(19) United States
(12) Patent Application Publication
(10) Pub. No.: US 2025/0142571 A1
(43) Pub. Date: May 1, 2025

(54) METHOD AND DEVICE IN NODES USED FOR WIRELESS COMMUNICATION

(71) Applicants: Qi JIANG, Shanghai (CN); Jinming QI, Shanghai (CN); Xiaobo ZHANG, Shanghai (CN)

(72) Inventors: Qi JIANG, Shanghai (CN); Jinming QI, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/921,035

(22) Filed: Oct. 21, 2024

(30) Foreign Application Priority Data
Nov. 1, 2023 (CN) 202311443755.4

(51) Int. Cl. H04W 72/20; H04W 72/044

(52) U.S. Cl. CPC H04W 72/20; H04W 72/046

(57) ABSTRACT

The present application discloses a method and a device in a node for wireless communications. A first node receives a first signaling, the first signaling being used to configure a first RS resource, a first signal and a second signal, the first signal being associated with a first device identification (ID); and receives the second signal, the second signal being associated with a second device ID; the first signaling is identified by the second device ID, the first RS resource is spatially correlated to the first signal, and whether receiving the second signal includes detecting the first signal depends on a spatial correlation between the second signal and the first RS resource. The present application optimizes the anti-interference capability of the terminal in interference scenarios, which in turn improves the overall reception performance.

### CROSS REFERENCE TO RELATED APPLICATIONS

This application claims the priority benefit of Chinese Patent Application No. CN202311443755.4, filed on Nov. 1, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In 2020, the vision of 5.5G industry for 5G evolution was first proposed by the industrial circles. In April 2021, the 3rd Generation Partner Project (3GPP) officially identified the name of 5.5G for 5G evolution as 5G-Advanced, which marks the start of the standardization process, and planned to define the 5G-Advanced technical specifications through Rel-18 (i.e., Release-18), Rel-19 and Rel-20. By the end of 2021, the Rel-18 has approved 28 projects, and 5.5G technology research and standardization has entered a substantial stage. Future Rel-19 and Rel-20 will further explore new 5G-Advanced services and architectures.

Reconfigurable Intelligent Surface (RIS) is an artificial electromagnetic surface structure with programmable electromagnetic properties, containing a large number of independent low-cost passive sub-wavelength resonant units. Each RIS unit has independent electromagnetic wave modulation capability, and the response of each unit to radio signals, such as phase, amplitude, polarization, etc., can be controlled by changing the parameters and spatial distribution of the RIS units. Through the superposition of wireless response signals of a large number of RIS units, specific beam propagation characteristics are formed on the macro level, thus forming a flexible and controllable formed beam to eliminate the coverage of blind zones, enhance the edge of the coverage and achieve the effect of increasing the rank of multi-stream transmission. RIS technology is characterized by low cost, low energy consumption and programmability, and is easy to deploy, and obtains high beamforming gain with larger antenna size, and thus is regarded as a key technology for research in the 5G-Advanced phase and one of the core visions of 6G.

### SUMMARY

In the RIS scenarios, in order to facilitate the flexible deployment of RIS, the control link of RIS will choose a wireless link. When the base station sends control signals to the RIS, according to the characteristics of the RIS, the RIS may also reflect the control signals of the RIS while receiving its control signals, and no matter the control signals used for the RIS directly from the base station, or the control signals that are reflected by the RIS, all of them will interfere with the downlink signals, and therefore the above interference needs to be suppressed or eliminated in the receiving end in order to ensure the reception quality.

To address the above problem, the present application provides a solution. It should be noted that although the original intent of this application is for RIS scenarios, this application can also be applied to other non-RIS scenarios, for instance, scenarios with relay or Repeater; further, the adoption of a unified design scheme for different scenarios (e.g., other non-RIS scenarios including, but not limited to, capacity augmentation systems, systems for near field communications, unlicensed spectrum communications, Internet of Things (IoT), Ultra Reliable Low Latency Communication (URLLC) networks, Vehicle-to-everything (V2X), etc.) also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Particularly, for interpretations of the terminology, nouns, functions and variables (unless otherwise specified) in the present application, refer to definitions given in TS38 series and TS37 series of 3GPP specifications. Refer to 3GPP TS38.211, TS38.212, TS38.213, TS38.214, TS38.215, TS38.300, TS38.304, TS38.305, TS38.321, TS38.331, TS37.355, and TS38.423, if necessary, for a better understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first signaling, the first signaling being used to configure a first RS resource, a first signal and a second signal, the first signal being associated with a first device identification (ID); and
receiving the second signal, the second signal being associated with a second device ID;
herein, the first signaling is identified by the second device ID, the first RS resource is spatially correlated to the first signal, and whether receiving the second signal includes detecting the first signal depends on a spatial correlation between the second signal and the first RS resource.

In one embodiment, a problem to be solved in the present application includes: how to eliminate interference of RIS control signals in a RIS scenario.

In one embodiment, a problem to be solved in the present application includes: how to solve the interference problem by utilizing the spatial correlation of the RIS control signal in a RIS scenario.

In one embodiment, a problem to be solved in the present application includes: how the first node can eliminate interference of the first signal.

In one embodiment, characteristics of the above method include that the receiving the second signal in the present application determines whether or not to include detecting the first signal according to the spatial correlation between the second signal and the first RS resource, thereby solving the above problem.

In one embodiment, characteristics of the above method include that the first RS resource is spatially correlated to the first signal, and whether receiving the second signal includes the detecting the first signal depends on a spatial correlation between the second signal and the first RS resource.

In one embodiment, characteristics of the above method include that the receiving the second signal in the present application includes the detecting the first signal when the second signal is spatially correlated with the first RS resource, which eliminates the interference of the first signal, thereby solving the above problem.

In one embodiment, characteristics of the above method include that the first signal comprises a control signal of the RIS, and when the second signal is spatially correlated to the first RS resource, the receiving the second signal includes the detecting the first signal, thus eliminating the interference of the RIS control signal.

In one embodiment, characteristics of the above method include that the second signal is a piece of data or control information sent to a terminal and is interfered with by the first signal, and that the interference of the first signal is resolved by using the spatial correlation between the second signal and the first RS resource.

In one embodiment, the benefits of the above method include that the spatial correlation of the control signals of the RIS with the first RS resource is reasonably utilized.

In one embodiment, the benefits of the above method include that it eliminates the interference caused by the control signals of the RIS to the first node.

In one embodiment, the benefits of the above method include that this application supports RIS technology, which has the advantages of eliminating coverage blind zones, enhancing edge coverage and increasing rank for multi-stream transmission.

In one embodiment, the benefits of the above method include that it enhances the anti-interference capability of the system and improves the robustness of the transmission.

In one embodiment, the benefits of the above method include that it helps to improve reliability of the transmission.

In one embodiment, the benefits of the above method include that it offers better parsing of the first signal and eliminates interference of the first signal.

According to one aspect of the present application, the above method is characterized in that the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

In one embodiment, characteristics of the above method include that it reduces the number of times of blind decoding for the second signal by using the spatial correlation between the second signal and the first RS resource.

In one embodiment, characteristics of the above method include that in instances when the second signal and the first RS resource are not spatially correlated, a greater number of times of blind decoding are performed for the second signal compared to the instances when the second signal and the first RS resource are spatially correlated.

In one embodiment, characteristics of the above method include that in instances when the second signal and the first RS resource are spatially correlated, a smaller number of times of blind decoding are performed for the second signal compared to the instances when the second signal and the first RS resource are not spatially correlated.

In one embodiment, characteristics of the above method include that it realizes interference elimination to reduce the number of blind decoding times by using the spatial correlation between the second signal and the first RS resource.

In one embodiment, the benefits of the above method include that it reduces the complexity of the receiving of the second signal by performing fewer times of blind decoding for the second signal when the second signal and the first RS resource are spatially correlated.

In one embodiment, the benefits of the above method include reducing the blind decoding burden of the terminal.

In one embodiment, the benefits of the above method include reducing the device complexity of the terminal.

In one embodiment, the benefits of the above method include helping the terminal to reduce the number of blind decoding times.

According to one aspect of the present application, the above method is characterized in that the second signal and the first RS resource are spatially correlated, the receiving the second signal including the detecting the first signal; or the second signal and the first RS resource are not spatially correlated, the receiving the second signal not including the detecting the first signal.

In one embodiment, characteristics of the above method include that it determines whether the receiving the second signal includes the detecting the first signal based on the spatial correlation between the second signal and the first RS resource.

In one embodiment, characteristics of the above method include that when the second signal and the first RS resource are spatially correlated, the receiving the second signal includes the detecting the first signal; when the second signal and the first RS resource are not spatially correlated, the receiving the second signal does not include the detecting the first signal.

In one embodiment, the benefits of the above method include that it determines whether the receiving the second signal includes the detecting the first signal or not according to the difference in the spatial correlation between the second signal and the first RS resource, thus enhancing the flexibility.

In one embodiment, the benefits of the above method include: enhancing the system flexibility.

In one embodiment, the benefits of the above method include: facilitating enhanced coverage and improving the quality of service and coverage of the system.

In one embodiment, the benefits of the above method include that it helps to flexibly handle the interference incurred by the first signal.

According to one aspect of the present application, the above method is characterized in that the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

In one embodiment, characteristics of the above method include that when the receiving the second signal includes the detecting the first signal, the decoding of the second signal includes rate matching, puncturing or interference cancellation for the first signal.

In one embodiment, the benefits of the above method include that it makes the bit stream length match with the actual transmission capacity.

In one embodiment, the benefits of the above method include that it reduces the interference of the first signal.

In one embodiment, the benefits of the above method include that it matches rates of data transmissions between the transmitter and the receiver.

According to one aspect of the present application, the above method is characterized in that the first signaling configures at least a former of the first device ID or the second device ID.

In one embodiment, characteristics of the above method include that the second node choses whether to use the first signaling to configure the second device ID.

In one embodiment, characteristics of the above method include that the first device ID is configured by the first signaling.

In one embodiment, characteristics of the above method include that the first device ID is used to identify the RIS.

In one embodiment, the benefits of the above method include that the first signaling selectively configures the second device ID, thus enhancing the flexibility.

In one embodiment, the benefits of the above method include streamlining the system design.

In one embodiment, the benefits of the above method include reducing signaling overhead.

According to one aspect of the present application, the above method is characterized in that a device identified by the first device ID is used to reflect a radio signal sent from a transmitter of the second signal.

In one embodiment, characteristics of the above method include that a device identified by the first device ID is a RIS, which reflects a radio signal from the transmitter of the second signal.

In one embodiment, characteristics of the above method include that one implementation of the device identified by the first device ID is a passive relay node that forwards signals by way of reflection.

In one embodiment, characteristics of the above method include that a transmitter of the second signal controls a device identified by the first device ID to reflect a radio signal from the transmitter of the second signal.

In one embodiment, the benefits of the above method include that the device identified by the first device ID reflects a radio signal from a transmitter of the second signal, which enhances the coverage of the transmitter of the second signal.

In one embodiment, the benefits of the above method include that the device identified by the first device ID reflects a radio signal from a transmitter of the second signal, which enhances cell coverage.

In one embodiment, the benefits of the above method include improving the performance for users at the edge of the cell.

According to one aspect of the present application, the above method is characterized in that the first signal and the second signal are respectively used for a first link and a second link; the first link corresponds to first-type devices, while the second link corresponds to terminals; the first-type devices are different from the terminals.

In one embodiment, characteristics of the above method include that the first signal is a control signal for the first-type device, the first-type device being a RIS.

In one embodiment, characteristics of the above method include that the first link is a link between a base station and a RIS, while the second link is a link between a base station and a terminal.

In one embodiment, characteristics of the above method include that what corresponds to the first-type device is the RIS.

In one embodiment, the benefits of the above method include: controlling the RIS and terminal with different signals, thus increasing system flexibility.

In one embodiment, the benefits of the above method include that the RIS improves additional indirect links for the transmission of signals, enhancing the coverage of the network.

In one embodiment, the benefits of the above method include: reducing the percentage of blind zones.

The present application provides a method in a second node for wireless communications, comprising:
transmitting a first signaling, the first signaling being used to configure a first RS resource, a first signal and a second signal, the first signal being associated with a first device identification (ID); and transmitting the second signal, the second signal being associated with a second device ID;
herein, the first signaling is identified by the second device ID, the first RS resource is spatially correlated to the first signal, and whether the second signal includes detecting the first signal when being received depends on a spatial correlation between the second signal and the first RS resource.

According to one aspect of the present application, the above method is characterized in that the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

According to one aspect of the present application, the above method is characterized in that the second signal and the first RS resource are spatially correlated, the receiving the second signal including the detecting the first signal; or the second signal and the first RS resource are not spatially correlated, the receiving the second signal not including the detecting the first signal.

According to one aspect of the present application, the above method is characterized in that the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

According to one aspect of the present application, the above method is characterized in that the first signaling configures at least a former of the first device ID or the second device ID.

According to one aspect of the present application, the above method is characterized in that a device identified by the first device ID is used to reflect a radio signal sent from a transmitter of the second signal.

According to one aspect of the present application, the above method is characterized in that the first signal and the second signal are respectively used for a first link and a second link; the first link corresponds to first-type devices, while the second link corresponds to terminals; the first-type devices are different from the terminals.

The present application provides a device of first node for wireless communications, comprising:
a first receiver, receiving a first signaling, the first signaling being used to configure a first RS resource, a first signal and a second signal, the first signal being associated with a first device identification (ID); and receiving the second signal, the second signal being associated with a second device ID;
herein, the first signaling is identified by the second device ID, the first RS resource is spatially correlated to the first signal, and whether receiving the second signal includes detecting the first signal depends on a spatial correlation between the second signal and the first RS resource.

The present application provides a device of second node for wireless communications, comprising:
a first transmitter, transmitting a first signaling, the first signaling being used to configure a first RS resource, a first signal and a second signal, the first signal being associated with a first device identification (ID); and transmitting the second signal, the second signal being associated with a second device ID;
herein, the first signaling is identified by the second device ID, the first RS resource is spatially correlated to the first signal, and whether the second signal includes detecting the first signal when being received depends on a spatial correlation between the second signal and the first RS resource.

In one embodiment, compared with the prior art, the present application is advantageous in the following aspects:
it supports RIS technology, which has the advantages of eliminating coverage blind zones, enhancing edge coverage and increasing rank for multi-stream transmission;
it favorably reduces or eliminates the interference of RIS control signals to users in RIS scenarios;
it improves transmission reliability and system performance;
it improves the robustness and anti-interference capability of signal transmission.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a flowchart of transmission between a second node and a third node according to one embodiment of the present application.

FIG. 7 illustrates a schematic diagram of blind decoding for a second signal according to one embodiment of the present application.

FIG. 8 illustrates a schematic diagram of a relationship between receiving a second signal and detecting a first signal according to one embodiment of the present application.

FIG. 9 illustrates a schematic diagram of the meaning of receiving a second signal including detecting a first signal according to one embodiment of the present application.

FIG. 10 illustrates a schematic diagram of a first signaling configuration according to one embodiment of the present application.

FIG. 11 illustrates a schematic diagram of device functionality identified by a first device ID according to one embodiment of the present application.

FIG. 12 illustrates a schematic diagram of relations between signals, links and devices according to one embodiment of the present application.

FIG. 13 illustrates a schematic diagram of Reconfigurable Intelligence Surface (RIS) according to one embodiment of the present application.

FIG. 14 illustrates a structure block diagram of a processing device in a first node according to one embodiment of the present application.

FIG. 15 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

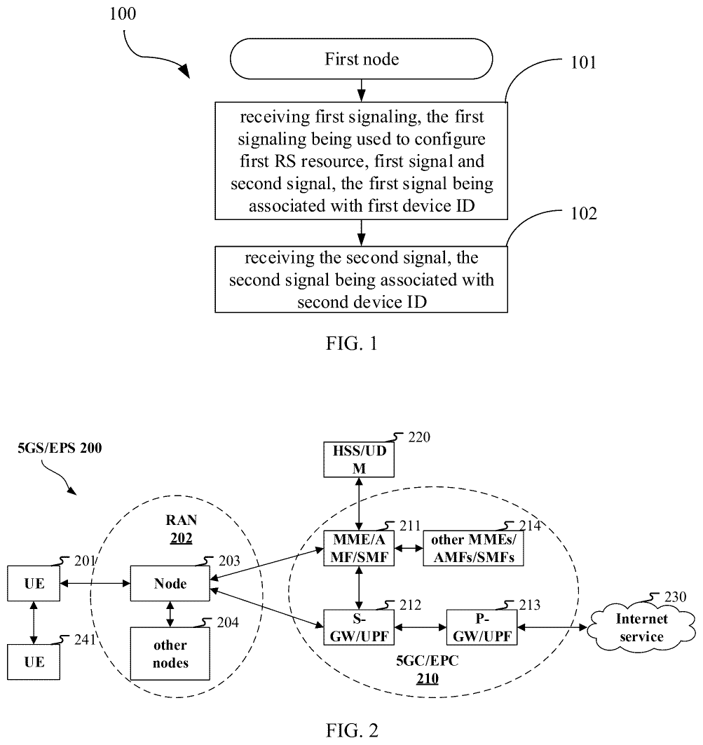

Embodiment 1 illustrates a flowchart 100 of transmission of a first node according to one embodiment of the present application, as shown in FIG. 1. In FIG. 1, each step represents a step, it should be particularly noted that the sequence order of each box herein does not restrict a chronological order of steps marked respectively by these boxes.

In Embodiment 1, the first node of the present application receives a first signaling in step 101, the first signaling being used to configure a first RS resource, a first signal and a second signal, the first signal being associated with a first device identification (ID); and the first node of the present application receives a second signal in step 102, the second signal being associated with a second device ID; the first signaling is identified by the second device ID, the first RS resource is spatially correlated to the first signal, and whether receiving the second signal includes detecting the first signal depends on a spatial correlation between the second signal and the first RS resource.

In one embodiment, the first signaling comprises a higher-layer signaling.

In one embodiment, the first signaling comprises a Radio Resource Control (RRC) signaling.

In one embodiment, the first signaling is transmitted via an RRC signaling.

In one embodiment, the first signaling comprises one or more RRC Information Elements (IEs).

In one embodiment, the first signaling comprises one or more fields in at least one RRC IE.

In one embodiment, the first signaling comprises all or part of fields in each one of multiple RRC IEs.

In one embodiment, the first signaling comprises a system broadcast information block.

In one embodiment, the first signaling comprises a System Information Block (SIB).

In one embodiment, the first signaling comprises a System Information Block 1 (SIB1).

In one embodiment, the first signaling comprises Remaining Minimum System Information (RMSI).

In one embodiment, the first signaling comprises partial or all fields in a SIB.

In one embodiment, the first signaling comprises Downlink Control Information (DCI).

In one embodiment, the first signaling comprises a scheduling DCI.

In one embodiment, the first signaling comprises a non-scheduling DCI.

In one embodiment, the first signaling comprises a Medium Access Control (MAC) layer signaling.

In one embodiment, the first signaling comprises a MAC Control Element (CE).

In one embodiment, a name of the first signaling includes “RIS”.

In one embodiment, a name of the first signaling includes “IRS”.

In one embodiment, a name of the first signaling includes “Iner-Cell”.

In one embodiment, a physical layer channel occupied by the first signaling includes a Physical Downlink Control CHannel (PDCCH).

In one embodiment, a physical layer channel occupied by the first signaling includes a Physical Downlink Shared CHannel (PDSCH).

In one embodiment, the first signaling is transmitted via an air interface.

In one embodiment, the first signaling is transmitted via a radio interface.

In one embodiment, the first RS resource is a resource occupied by at least a Synchronization Signal in a system subsequent to a 5G system.

In one embodiment, the first RS resource is a resource occupied by at least a Synchronization Signal in a 6G system.

In one embodiment, the first RS resource is a Channel State Information-Reference Signal (CSI-RS) resource or a Synchronization Signal Block (SSB).

In one embodiment, the first RS resource comprises a CSI-RS resource.

In one embodiment, the first RS resource is a CSI-RS resource.

In one embodiment, the first RS resource comprises a non-zero-power (NZP) CSI-RS resource.

In one embodiment, the first RS resource corresponds to a Reference Signal (RS) Resource Identification (Id).

In one embodiment, the RS Resource Id in this application is used to identify one RS resource.

In one embodiment, the RS Resource Id in this application is an index of one RS resource.

In one embodiment, the RS Resource Id in this application comprises a configuration index of one RS resource.

In one embodiment, the RS resource Id in this application is a configuration index of one RS resource.

In one embodiment, the first RS resource corresponds to an NZP-CSI-RS-ResourceId.

In one embodiment, the first RS resource corresponds to a CSI-ResourceConfigId.

In one embodiment, the first RS resource corresponds to a CSI-RS resource set.

In one embodiment, the first RS resource corresponds to an NZP CSI-RS resource set.

In one embodiment, the first RS resource corresponds to one RS resource set identity.

In one embodiment, the one RS resource set identity in this application is used to identify the one RS resource set.

In one embodiment, the one RS resource set identity in this application is an index of the one RS resource set.

In one embodiment, the one RS resource set identity in this application comprises a configuration index of the one RS resource set.

In one embodiment, the first RS resource corresponds to an NZP-CSI-RS-ResourceSetId.

In one embodiment, the first RS resource comprises an RS.

In one embodiment, the first RS resource comprises a Reference Signal (RS) transmitted in the first RS resource.

In one embodiment, the first RS resource is a CSI-RS resource set.

In one embodiment, the first RS resource is an NZP CSI-RS resource set.

In one embodiment, the first RS resource comprises an SSB.

In one embodiment, the first RS resource is an SSB.

In one embodiment, the first RS resource corresponds to an SSB-Index.

In one embodiment, the first RS resource corresponds to an ssb-Index.

In one embodiment, the first RS resource comprises one or more port(s).

In one subembodiment, the one or more port(s) comprised in the first RS resource is/are respectively CSI-RS port(s).

In one subembodiment, the one or more port(s) comprised in the first RS resource is/are respectively Antenna port(s).

In one embodiment, the first RS resource occupies at least one symbol in time domain.

In one embodiment, the first RS resource occupies multiple consecutive symbols in time domain.

In one embodiment, the first RS resource occupies one slot in time domain.

In one embodiment, the first RS resource occupies one sub-frame in time domain.

In one embodiment, the first RS resource occupies at least one sub-band in frequency domain.

In one embodiment, the first RS resource occupies at least one Resource Block (RB) in frequency domain.

Typically, an RB occupies 12 consecutive subcarriers in frequency domain.

In one embodiment, the first RS resource occupies a group of downlink Physical Resource Blocks (PRBs).

In one embodiment, the first RS resource occupies at least one Resource Element (RE).

Typically, an RE occupies a symbol in the time domain and a subcarrier in the frequency domain.

In one embodiment, the first RS resource comprises an RS resource used for a Control link.

In one embodiment, the first RS resource comprises an RS resource used for a Backhaul link.

In one embodiment, the first RS resource comprises an RS resource used for an Access link.

In one embodiment, the first RS resource comprises an RS resource used for a Uu interface.

In one embodiment, the first RS resource corresponds to a Transmission Configuration Indicator (TCI).

In one embodiment, the first RS resource corresponds to a TCI-State.

In one embodiment, the first RS resource corresponds to a TCI-StateId.

In one embodiment, the meaning of “being used to configure” in the present application includes: indicating.

In one embodiment, the meaning of “being used to configure” in the present application includes: comprising.

In one embodiment, the meaning of “being used to configure” in the present application includes: configuring.

In one embodiment, the meaning of “being used to configure” in the present application includes: being used to determine.

In one embodiment, the meaning of “indicating” in the present application includes: explicitly indicating.

In one embodiment, the meaning of “indicating” in the present application includes: implicitly indicating.

In one embodiment, the first signaling is used to simultaneously configure the first RS resource, the first signal and the second signal.

In one embodiment, an RRC signaling carried in a PDSCH indicated by the first signaling is used to configure the first RS resource, the first signal and the second signal.

In one embodiment, the first signaling comprises multiple sub-signalings, the multiple sub-signalings configuring the first RS resource, the first signal and the second signal, respectively.

In one embodiment, the meaning of the characteristic “the first signaling being used to configure a first RS resource” comprises: the first signaling indicating a Frequency domain resource occupied by the first RS resource.

In one embodiment, the meaning of the characteristic “the first signaling being used to configure a first RS resource” comprises: the first signaling indicating a Time domain resource occupied by the first RS resource.

In one embodiment, the meaning of the characteristic “the first signaling being used to configure a first RS resource” comprises: the first signaling indicating REs occupied by the first RS resource.

In one embodiment, the meaning of the characteristic “the first signaling being used to configure a first RS resource” comprises: the first signaling indicating a period of the first RS resource.

In one embodiment, the meaning of the characteristic “the first signaling being used to configure a first RS resource” comprises: the first signaling indicating a configuration period of the first RS resource.

In one embodiment, the meaning of the characteristic “the first signaling being used to configure a first RS resource” comprises: the first signaling indicating an RS resource type of the first RS resource.

In one subembodiment, the RS resource type includes one of periodic, semi-persistent and aperiodic.

In one embodiment, the meaning of the characteristic “the first signaling being used to configure a first RS resource” comprises: the first signaling indicating a transmission power value of an RS transmitted in the first RS resource.

In one embodiment, the meaning of the characteristic “the first signaling being used to configure a first RS resource” comprises: the first signaling indicating an ID of the first RS resource.

In one embodiment, the meaning of the characteristic “the first signaling being used to configure a first RS resource” comprises: the first signaling indicating an Index of the first RS resource.

In one embodiment, the meaning of the characteristic “the first signaling being used to configure a first RS resource” comprises: the first signaling indicating a QCL relation of the first RS resource.

In one embodiment, the meaning of the characteristic “the first signaling being used to configure a first RS resource” comprises: the first signaling indicating a TCI-State of the first RS resource.

In one embodiment, the meaning of the characteristic “the first signaling being used to configure a first RS resource” comprises: the first signaling indicating a TCI-StateId of the first RS resource.

In one embodiment, the QCL in this application refers to Quasi Co-Location.

In one embodiment, the QCL in this application refers to Quasi Co-Located.

In one embodiment, the QCL in this application comprises QCL parameters.

In one embodiment, the QCL in this application comprises QCL assumption.

In one embodiment, the QCL type in this application includes TypeA, TypeB, TypeC and TypeD.

In one embodiment, the QCL type in this application includes Type(s) other than TypeA, TypeB, TypeC and TypeD.

In one embodiment, the QCL parameters in the present application of which the QCL type is TypeA include a Doppler shift, a Doppler spread, an average delay and a delay spread; the QCL parameters in the present application of which the QCL type is TypeB include a Doppler shift and a Doppler spread; the QCL parameters in the present application of which the QCL type is TypeC include a Doppler shift and an average delay; the QCL parameters in the present application of which the QCL type is TypeD include a spatial Rx parameter.

In one embodiment, the QCL in the present application includes at least one of a Doppler shift, a Doppler spread, an average delay, a delay spread, a Spatial Tx parameter or a Spatial Rx parameter.

In one embodiment, the first signaling is used to configure time-frequency resources occupied by the first signal.

In one embodiment, the first signaling allocates or configures time-domain resources and frequency-domain resources occupied by the first signal.

In one embodiment, a field comprised in the first signaling is used to configure time-frequency resources occupied by the first signal.

In one embodiment, multiple fields comprised in the first signaling are used to configure time-domain resources and frequency-domain resources occupied by the first signal, respectively.

In one embodiment, the first signaling is used to indicate a transmission power value of the first signal.

In one embodiment, the first signaling is used to indicate resource mapping of the first signal.

In one embodiment, the first signaling is used to indicate a Modulation and Coding Scheme (MCS) of the first signal.

In one subembodiment, the MCS indicates a terminal modulation method, a coding rate and a transmission block size.

In one embodiment, the first signaling is used to configure a Control Resource Set (CORESET) occupied by a candidate corresponding to the first signal.

In one embodiment, the first signaling is used to configure a search space occupied by a candidate corresponding to the first signal.

In one embodiment, the first signaling is used to configure a search space set occupied by a candidate corresponding to the first signal.

In one subembodiment of the above three embodiments, the candidate corresponding to the first signal comprises a PDCCH candidate.

In one subembodiment of the above three embodiments, the candidate corresponding to the first signal comprises a candidate for communication between a base station and a RIS.

In one subembodiment of the above three embodiments, the candidate corresponding to the first signal comprises a candidate for control signaling for transmission of a base station and a RIS.

In one embodiment, the first signaling is used to configure an identifier corresponding to the first signal.

In one subembodiment, the identifier corresponding to the first signal is the first device ID.

In one subembodiment, the identifier corresponding to the first signal is used for scrambling the first signal.

In one subembodiment, the identifier corresponding to the first signal includes a Radio Network Temporary Identifier (RNTI).

In one subembodiment, the identifier corresponding to the first signal is a Cell Radio Network Temporary Identifier (C-RNTI).

In one subembodiment, the identifier corresponding to the first signal is a Reconfigurable Intelligent Surface Radio Network Temporary Identifier (RIS-RNTI).

In one subembodiment, the identifier corresponding to the first signal is an Intelligent Reflecting Surface Radio Network Temporary Identifier (IRS-RNTI).

In one subembodiment, the identifier corresponding to the first signal is a Reconfigurable intelligent surface Radio Network Temporary Identifier (R-RNTI).

In one embodiment, the first signaling is used to configure time-frequency resources occupied by the second signal.

In one embodiment, the first signaling allocates or configures time-domain resources and frequency-domain resources occupied by the second signal.

In one embodiment, a field comprised in the first signaling is used to configure time-frequency resources occupied by the second signal.

In one embodiment, multiple fields comprised in the first signaling are used to configure time-domain resources and frequency-domain resources occupied by the second signal, respectively.

In one embodiment, the first signaling is used to indicate resource mapping of the second signal.

In one embodiment, the first signaling is used to configure a CORESET occupied by a candidate corresponding to the second signal.

In one embodiment, the first signaling is used to configure a search space occupied by a candidate corresponding to the second signal.

In one embodiment, the first signaling is used to configure a search space set occupied by a candidate corresponding to the second signal.

In one subembodiment of the above three embodiments, the candidate corresponding to the second signal comprises a PDCCH candidate.

In one subembodiment of the above three embodiments, the candidate corresponding to the second signal comprises a candidate for communication between a base station and a terminal.

In one embodiment, the first signaling is used to configure an identifier corresponding to the second signal.

In one subembodiment, the identifier corresponding to the second signal is the second device ID.

In one subembodiment, the identifier corresponding to the second signal is used for scrambling the second signal.

In one subembodiment, the Cyclic Redundancy Check (CRC) of the second signal is scrambled by the identifier corresponding to the second signal.

In one subembodiment, the identifier corresponding to the second signal includes the RNTI.

In one subembodiment, the identifier corresponding to the second signal is a C-RNTI.

In one subembodiment, the identifier corresponding to the second signal is a System Information RNTI (SI-RNTI).

In one subembodiment, the identifier corresponding to the second signal is a Configured Scheduling RNTI (CS-RNTI).

In one subembodiment, the identifier corresponding to the second signal is a Modulation Coding Scheme Cell RNTI (MCS-C-RNTI).

In one subembodiment, the identifier corresponding to the second signal is a Group RNTI (G-RNTI).

In one subembodiment, the identifier corresponding to the second signal is a Group Configured Scheduling RNTI (G-CS-RNTI).

In one subembodiment, the identifier corresponding to the second signal is a Multicast broadcast services Control CHannel RNTI (MCCH-RNTI).

In one subembodiment, the identifier corresponding to the second signal is a Slot Format Indication RNTI (SFI-RNTI).

In one subembodiment, the identifier corresponding to the second signal is an Interruption RNTI (INT-RNTI).

In one subembodiment, the identifier corresponding to the second signal is a Transmit Power Control-Physical Uplink Shared CHannel-RNTI (TPC-PUSCH-RNTI).

In one subembodiment, the identifier corresponding to the second signal is a Transmit Power Control-Physical Uplink Control CHannel-RNTI (TPC-PUCCH-RNTI).

In one subembodiment, the identifier corresponding to the second signal is a Transmit Power Control-Sounding Reference Signal-RNTI (TPC-SRS-RNTI).

In one subembodiment, the identifier corresponding to the second signal is a Semi-Persistent Channel State Information RNTI (SP-CSI-RNTI).

In one subembodiment, the identifier corresponding to the second signal is a Sidelink RNTI (SL-RNTI).

In one subembodiment, the identifier corresponding to the second signal is a Sidelink Configured Scheduling RNTI (SL-CS-RNTI).

In one subembodiment, the identifier corresponding to the second signal is an Availability indication RNTI (AI-RNTI).

In one subembodiment, the identifier corresponding to the second signal is a Cancellation Indication RNTI (CI-RNTI).

In one embodiment, the first signal comprises a baseband signal.

In one embodiment, the first signal comprises a radio frequency signal.

In one embodiment, the first signal comprises a radio signal.

In one embodiment, the first signal comprises DCI.

In one embodiment, the first signal comprises a CSI-RS.

In one embodiment, the first signal carries control information of the RIS.

In one embodiment, the first signal carries ON-OFF information of the RIS.

In one embodiment, a physical layer channel occupied by the first signal includes a PDCCH.

In one embodiment, the first signal is used to control a node other than the first node.

In one embodiment, the first signal is used to control a RIS.

In one embodiment, the first signal is used to control a reflection unit of the RIS.

In one embodiment, the first signal is used to control a phase of a reflection unit of the RIS.

In one embodiment, the first signal is used to control a reflective element of the RIS.

In one embodiment, the first signal is used to control a phase of a reflective element of the RIS.

In one embodiment, the first signal is used to control on or off of the RIS.

In one subembodiment, the turning on of the RIS comprises the RIS starting a reflective function.

In one subembodiment, the turning on of the RIS comprises the RIS starting to reflect radio signals.

In one subembodiment, the turning on of the RIS comprises turning on of a RIS control module.

In one subembodiment, the turning off of the RIS comprises turning off of a module of the RIS for receiving control information.

In one subembodiment, the turning off of the RIS comprises the RIS stopping reflecting radio signals.

In one subembodiment, the turning off of the RIS comprises the RIS turning off a function of reflecting signals.

In one embodiment, the first signal is used to control beam forwarding of a RIS.

In one embodiment, the first signal is used to indicate a beam pattern of a RIS.

In one embodiment, the first signal is used to indicate a beam index of a RIS.

In one embodiment, the first signal is used to indicate a beam pattern index of a RIS.

In one embodiment, the first signal is used to indicate beam information of a RIS.

In one embodiment, the first signal is used to indicate beam transition of a RIS.

In one embodiment, the first signal is used to indicate beam switching of a RIS.

In one embodiment, the first signal is used for beam indication of a RIS.

In one subembodiment, when the first signal is used for beam indication of the RIS, the first signal comprises at least: a beam index, or a time-domain resource.

In one embodiment, the first signal is used to indicate a beam pattern used by a RIS.

In one embodiment, the first signal is used to indicate a forwarding beam pattern used by a RIS.

In one embodiment, the first signal is used to control the effective time of a RIS.

In one embodiment, the first signal is used to control a duration of a RIS.

In one embodiment, the first signal is used to control a muting time of a RIS.

In one embodiment, the first signal is used for synchronization between a RIS and a base station.

In one embodiment, the first signal is used for measurements between a RIS and a base station.

In one embodiment, the first signal is used for measuring a link between a RIS and a base station.

In one embodiment, the first signal is used for a link between the second node and the third node of the present application.

In one embodiment, the first signal is for a link between a base station and a RIS.

In one embodiment, the first signal is for a link between a base station and a RIS control unit.

In one embodiment, the first signal is for a link between a RIS control unit and the RIS.

In one embodiment, the first signal is used for a wireless link.

In one embodiment, the first signal is used for a control link.

In one embodiment, the first signal is used for a backhaul link.

In one embodiment, the first signal is used for a RIS incidence link.

In one embodiment, the first signal is used for a RIS reflective link.

In one embodiment, the second signal comprises a baseband signal.

In one embodiment, the second signal comprises a radio frequency signal.

In one embodiment, the second signal comprises a radio signal.

In one embodiment, the second signal comprises DCI.

In one embodiment, the second signal comprises scheduling DCI.

In one embodiment, the second signal comprises non-scheduling DCI.

In one embodiment, a physical layer channel occupied by the second signal includes a PDCCH.

In one embodiment, a physical layer channel occupied by the second signal includes a PDSCH.

In one embodiment, a physical layer channel occupied by the second signal includes a Physical Broadcast CHannel (PBCH).

In one embodiment, the second signal comprises a CSI-RS.

In one embodiment, the second signal is used for controlling the first node.

In one embodiment, the second signal comprises a scheduling signaling of the first node.

In one embodiment, the second signal comprises data of the first node.

In one embodiment, the second signal is used for a link between the second node and the third node of the present application.

In one embodiment, the second signal is for a link between a base station and a terminal.

In one embodiment, the second signal is for a link between a base station and a UE (i.e., User Equipment).

In one embodiment, the second signal is used for a wireless link.

In one embodiment, the second signal is used for an access link.

In one embodiment, there exists an overlap in time-frequency resources between the first signal and the second signal.

In one embodiment, there exists at least one Resource Element (RE) being occupied by both the first signal and the second signal.

In one embodiment, at least one RE is occupied by both the first signal and the second signal on a same time-domain symbol.

In one embodiment, the characteristic “the first signal being associated with a first device identification (ID)” means that the first signal is identified by the first device ID.

In one embodiment, the characteristic “the first signal being associated with a first device identification (ID)” means that the CRC included in the first signal is scrambled by the first device ID.

In one embodiment, the characteristic “the first signal being associated with a first device identification (ID)” means that the first signal is generated by the first device ID.

In one embodiment, the characteristic “the first signal being associated with a first device identification (ID)” means that a DeModulation Reference Signal (DMRS) included in the first signal is generated by the first device ID.

In one embodiment, the characteristic “the first signal being associated with a first device identification (ID)” means that a DMRS included in a physical layer channel carrying the first signal is generated by the first device ID.

In one embodiment, the characteristic “the first signal being associated with a first device identification (ID)” means that a DMRS included in the first signal is scrambled by the first device ID.

In one embodiment, the characteristic “the first signal being associated with a first device identification (ID)” means that a DMRS included in a physical layer channel carrying the first signal is scrambled by the first device ID.

In one embodiment, the characteristic “the second signal being associated with a second device identification (ID)” means that the second signal is identified by the second device ID.

In one embodiment, the characteristic “the second signal being associated with a second device identification (ID)” means that the CRC included in the second signal is scrambled by the second device ID.

In one embodiment, the characteristic “the second signal being associated with a second device identification (ID)” means that the second signal is generated by the second device ID.

In one embodiment, the characteristic “the second signal being associated with a second device identification (ID)” means that a DMRS included in the second signal is generated by the second device ID.

In one embodiment, the characteristic “the second signal being associated with a second device identification (ID)” means that a DMRS included in a physical layer channel carrying the second signal is generated by the first device ID.

In one embodiment, the characteristic “the second signal being associated with a second device identification (ID)” means that a DMRS included in the second signal is scrambled by the second device ID.

In one embodiment, the characteristic “the second signal being associated with a second device identification (ID)” means that a DMRS included in a physical layer channel carrying the second signal is scrambled by the second device ID.

In one embodiment, the characteristic “the first signaling is identified by the second device ID” means that the CRC included in the first signaling is scrambled by the second device ID.

In one embodiment, the characteristic “the first signaling is identified by the second device ID” means that the first signaling is generated by the second device ID.

In one embodiment, the characteristic “the first signaling is identified by the second device ID” means that a DMRS included in the first signaling is scrambled by the second device ID.

In one embodiment, the characteristic “the first signaling is identified by the second device ID” means that a DMRS included in a physical layer channel carrying the first signaling is generated by the second device ID.

In one embodiment, the characteristic “the first signaling is identified by the second device ID” means that a DMRS included in the first signaling is scrambled by the second device ID.

In one embodiment, the characteristic “the first signaling is identified by the second device ID” means that a DMRS included in a physical layer channel carrying the first signaling is scrambled by the second device ID.

In one embodiment, the characteristic “the first signaling is identified by the second device ID” means that the first signaling is associated with the second device ID.

In one embodiment, the meaning of the characteristic “the first RS resource is spatially correlated to the first signal” comprises: the first RS resource is QCL with the first signal.

In one embodiment, the meaning of the characteristic “the first RS resource is spatially correlated to the first signal” comprises: a radio signal received in the first RS resource is QCL with the first signal.

In one embodiment, the meaning of the characteristic “the first RS resource is spatially correlated to the first signal” comprises: a radio signal received in the first RS resource uses the same spatial reception (Rx) parameters as the first signal.

In one embodiment, the meaning of the characteristic “the first RS resource is spatially correlated to the first signal” comprises: a radio signal received in the first RS resource uses the same received spatial parameters as the first signal.

In one embodiment, the meaning of the characteristic “the first RS resource is spatially correlated to the first signal” comprises: a radio signal received in the first RS resource uses the same received spatial filtering parameters as the first signal.

In one embodiment, the meaning of the characteristic “the first RS resource is spatially correlated to the first signal” comprises: a radio signal received in the first RS resource uses the same spatial-domain filtering as the first signal.

In one embodiment, the meaning of the characteristic “the first RS resource is spatially correlated to the first signal” comprises: a radio signal received in the first RS resource uses the same spatial filtering as the first signal.

In one embodiment, the meaning of the characteristic “the first RS resource is spatially correlated to the first signal” comprises: a radio signal received in the first RS resource uses the same received spatial filtering as the first signal.

In one embodiment, the meaning of the characteristic “the first RS resource is spatially correlated to the first signal” comprises: a radio signal received in the first RS resource is used to determine a spatial-domain filtering of the first signal.

In one embodiment, the meaning of the characteristic “the first RS resource is spatially correlated to the first signal” comprises: received spatial filtering parameters of a radio signal received in the first RS resource are used to determine received spatial filtering parameters of the first signal.

In one embodiment, the meaning of the characteristic “the first RS resource is spatially correlated to the first signal” comprises: the first RS resource is used to determine spatial reception (Rx) parameters of the first signal.

In one embodiment, the meaning of the characteristic “the first RS resource is spatially correlated to the first signal” comprises: the first RS resource is used to determine received spatial parameters of the first signal.

In one embodiment, the meaning of the characteristic “the first RS resource is spatially correlated to the first signal” comprises: the first RS resource is used to determine received spatial filtering parameters of the first signal.

In one embodiment, the meaning of the characteristic “the first RS resource is spatially correlated to the first signal” comprises: the first RS resource is used to determine a spatial-domain filtering of the first signal.

In one embodiment, the meaning of the characteristic “the first RS resource is spatially correlated to the first signal” comprises: the first RS resource is used to determine a spatial filtering of the first signal.

In one embodiment, the meaning of the characteristic “the first RS resource is spatially correlated to the first signal” comprises: the first RS resource is used to determine a received spatial filtering of the first signal.

In one embodiment, the meaning of the characteristic “the first RS resource is spatially correlated to the first signal” comprises: a radio signal received in the first RS resource uses the same DownLink Reception Spatial Filter (DL RX Spatial Filter) as the first signal.

In one embodiment, the meaning of the characteristic “the first RS resource is spatially correlated to the first signal” comprises: the first node receives the first signal according to a spatial relation with reference to a radio signal received in the first RS resource.

In one embodiment, a DeModulation Reference Signal (DMRS) antenna port of the first signal is quasi co-located (QCL) with an antenna port of the first RS resource.

In one embodiment, an antenna port used by the first signal is QCL with an antenna port of the first RS resource.

In one embodiment, the detecting the first signal comprises resuming the first signal having been received.

In one embodiment, the detecting the first signal comprises whitening the interference of the first signal to the second signal.

In one embodiment, the detecting the first signal comprises eliminating the interference of the first signal to the second signal.

In one embodiment, the detecting the first signal comprises eliminating the influence of the first signal to the second signal.

In one embodiment, the detecting the first signal comprises rate matching for the first signal.

In one embodiment, the detecting the first signal comprises puncturing for the first signal.

In one embodiment, the detecting the first signal comprises interference cancellation for the first signal.

In one embodiment, the first signal occupies at least a first channel, and the detecting the first signal comprises performing channel decoding for the first channel.

In one embodiment, the first signal occupies at least a second RS resource, the detecting the first signal comprising receiving a reference signal on the second RS resource, or performing channel estimation on a reference signal on the second RS resource.

In one embodiment, when the second signal and the first RS resource are spatially correlated, the receiving the second signal includes the detecting the first signal; when the second signal and the first RS resource are not spatially correlated, the receiving the second signal does not include the detecting the first signal.

In one embodiment, when the second signal and the first RS resource are spatially correlated, the first node determines on its own whether the receiving the second signal includes the detecting the first signal; when the second signal and the first RS resource are not spatially correlated, the receiving the second signal does not include the detecting the first signal.

In one embodiment, when the second signal and the first RS resource are spatially correlated, the receiving the second signal includes the detecting the first signal; when the second signal and the first RS resource are not spatially correlated, the first node determines on its own whether the receiving the second signal includes the detecting the first signal.

In one embodiment, when the second signal and the first RS resource are spatially correlated, the first node determines via a second signaling whether the receiving the second signal includes the detecting the first signal; when the second signal and the first RS resource are not spatially correlated, the receiving the second signal does not include the detecting the first signal.

In one embodiment, when the second signal and the first RS resource are spatially correlated, the first node comprises the detecting the first signal; when the second signal and the first RS resource are not spatially correlated, the first node determines via the second signaling whether the receiving the second signal includes the detecting the first signal.

In one subembodiment of the above two embodiments, the second signaling is a sub-signaling of the first signaling.

In one subembodiment of the above two embodiments, the second signaling belongs to the first signaling.

In one subembodiment of the above two embodiments, the second signaling is an additional signaling different from the first signaling.

In one embodiment, a higher layer signaling sent by the first node or a higher layer signaling received by the first node is transmitted via a radio signal that is associated to the second device ID.

In one embodiment, the meaning of the second signal and the first RS resource being spatially correlated comprises that the first RS resource and the second signaling are QCL.

In one embodiment, the meaning of the second signal and the first RS resource being spatially correlated comprises that a radio signal received in the first RS resource and the second signal are QCL.

In one embodiment, the meaning of the second signal and the first RS resource being spatially correlated comprises that a radio signal received in the first RS resource uses the same spatial reception (Rx) parameters as the second signal.

In one embodiment, the meaning of the second signal and the first RS resource being spatially correlated comprises that a radio signal received in the first RS resource uses the same received spatial parameters as the second signal.

In one embodiment, the meaning of the second signal and the first RS resource being spatially correlated comprises that a radio signal received in the first RS resource uses the same received spatial filtering parameters as the second signal.

In one embodiment, the meaning of the second signal and the first RS resource being spatially correlated comprises that a radio signal received in the first RS resource uses the same spatial-domain filtering as the second signal.

In one embodiment, the meaning of the second signal and the first RS resource being spatially correlated comprises that a radio signal received in the first RS resource uses the same spatial filtering as the second signal.

In one embodiment, the meaning of the second signal and the first RS resource being spatially correlated comprises that a radio signal received in the first RS resource uses the same received spatial filtering as the second signal.

In one embodiment, the meaning of the second signal and the first RS resource being spatially correlated comprises that a radio signal received in the first RS resource is used to determine a spatial-domain filtering of the second signal.

In one embodiment, the meaning of the second signal and the first RS resource being spatially correlated comprises that received spatial filtering parameters of a radio signal received in the first RS resource are used to determine received spatial filtering parameters of the second signal.

In one embodiment, the meaning of the second signal and the first RS resource being spatially correlated comprises that the first RS resource is used to determine spatial reception (Rx) parameters of the second signal.

In one embodiment, the meaning of the second signal and the first RS resource being spatially correlated comprises that the first RS resource is used to determine received spatial parameters of the second signal.

In one embodiment, the meaning of the second signal and the first RS resource being spatially correlated comprises that the first RS resource is used to determine received spatial filtering parameters of the second signal.

In one embodiment, the meaning of the second signal and the first RS resource being spatially correlated comprises that the first RS resource is used to determine a spatial-domain filtering of the second signal.

In one embodiment, the meaning of the second signal and the first RS resource being spatially correlated comprises that the first RS resource is used to determine a spatial filtering of the second signal.

In one embodiment, the meaning of the second signal and the first RS resource being spatially correlated comprises that the first RS resource is used to determine a received spatial filtering of the second signal.

In one embodiment, the meaning of the second signal and the first RS resource being spatially correlated comprises that a radio signal received in the first RS resource uses the same DL RX Spatial Filter as the second signal.

In one embodiment, the meaning of the second signal and the first RS resource being spatially correlated comprises that the first node receives the second signal according to a spatial relation with reference to a radio signal received in the first RS resource.

In one embodiment, a DeModulation Reference Signal (DMRS) antenna port of the second signal is quasi co-located (QCL) with an antenna port of the first RS resource.

In one embodiment, an antenna port used by the second signal is QCL with an antenna port of the first RS resource.

In one embodiment, the first signaling is sent to the first node by a base station.

In one embodiment, the first signaling is sent to a user by a base station.

In one embodiment, the first signaling is sent to the first node by the second node.

In one embodiment, the first RS resource is QCL with one RS resource configured between the second node and the third node in this application.

In one embodiment, the first RS resource is spatially correlated with one RS resource configured between the second node and the third node in this application.

In one embodiment, the first signal is a control signal sent from the second node to the third node in this application, and the first node monitors the first signal.

In one embodiment, the first node is directly connected to the second node without being reflected by the third node.

In one embodiment, the first node is a terminal.

In one embodiment, the first node is a UE.

In one embodiment, the second node is a base station.

In one embodiment, the second node is a network device used for controlling RIS.

In one embodiment, the third node comprises a RIS.

In one embodiment, the third node comprises a RIS group.

In one embodiment, the third node comprises multiple RIS panels.

In one embodiment, the third node is a RIS.

In one embodiment, the third node is multiple RISs.

In one embodiment, the third node is a RIS group.

In one embodiment, the third node comprises a module for receiving a control signaling for controlling the RIS.

In one embodiment, the third node comprises a control module for controlling the RIS.

In one embodiment, the third node is a control module for RIS.

In one embodiment, the “RIS” and “IRS” in this application are equivalent and interchangeable.

### Embodiment 2

Embodiment 2 illustrates a schematic diagram of a network architecture according to one embodiment of the present application, as shown in FIG. 2.

FIG. 2 illustrates a network architecture of Long-Term Evolution (LTE), Long-Term Evolution Advanced (LTE-A) and future 5G systems. The network architecture of the LTE, LTE-A and future 5G systems may be called an Evolved Packet System (EPS). The 5G NR or LTE network architecture may be referred to as 5G System (5GS)/EPS 200 or some other suitable terminology. The 5GS/EPS 200 may comprise one or more UEs 201, a UE 241 in sidelink communication with the UE(s) 201, an NG-RAN 202, a 5G Core Network/Evolved Packet Core (5G-CN/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane terminations. The gNB 203 can be connected to other gNBs 204 via an Xn interface (like backhaul). The gNB 203 may be called a base station, a base transceiver station, a radio base station, a radio transceiver, a transceiver function, a Basic Service Set (BSS), an Extended Service Set (ESS), a Transmitter Receiver Point (TRP) or some other applicable terms. The gNB 203 provides an access point of the 5G-CN/EPC 210 for the UE 201. Examples of UE 201 include cellular phones, smartphones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5G-CN/EPC 210 via an S1/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 itself is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and packet switching(PS) services.

In one embodiment, the first node in the present application includes the UE 201.

In one embodiment, the second node in the present application includes the gNB203.

In one embodiment, the UE 201 includes cellphone.

In one embodiment, the UE 201 is a means of transportation including automobile.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB203 is a flight platform.

In one embodiment, the gNB203 is satellite equipment.

In one embodiment, the gNB 203 is a piece of test equipment (e.g., a transceiving device simulating partial functions of the base station, or a signaling test instrument).

In one embodiment, a radio link from the UE 201 to the gNB 203 is an uplink, the uplink being used for performing uplink transmission.

In one embodiment, a radio link from the gNB 203 to the UE 201 is a downlink, the downlink being used for performing downlink transmission.

In one embodiment, a radio link between the UE201 and the gNB203 includes a cellular link.

In one embodiment, the UE 201 and the gNB 203 are connected to each other via a Uu air interface.

In one embodiment, a transmitter of the first signaling includes the gNB 203.

In one embodiment, a receiver of the first signaling includes the UE 201.

In one embodiment, a transmitter of the first signal includes the gNB 203.

In one embodiment, a transmitter of the second signal includes the gNB 203.

In one embodiment, a receiver of the second signal includes the UE 201.

In one embodiment, the UE 201 supports Reconfigurable Intelligent Surface (RIS).

In one embodiment, the gNB 203 supports RIS.

In one embodiment, the UE 201 supports 5G systems.

In one embodiment, the UE 201 supports 6G systems.

In one embodiment, the gNB 203 supports 5G systems.

In one embodiment, the gNB 203 supports 6G systems.

In one embodiment, the UE 201 at least supports 6G systems.

In one embodiment, the gNB 203 at least supports 6G systems.

### Embodiment 3

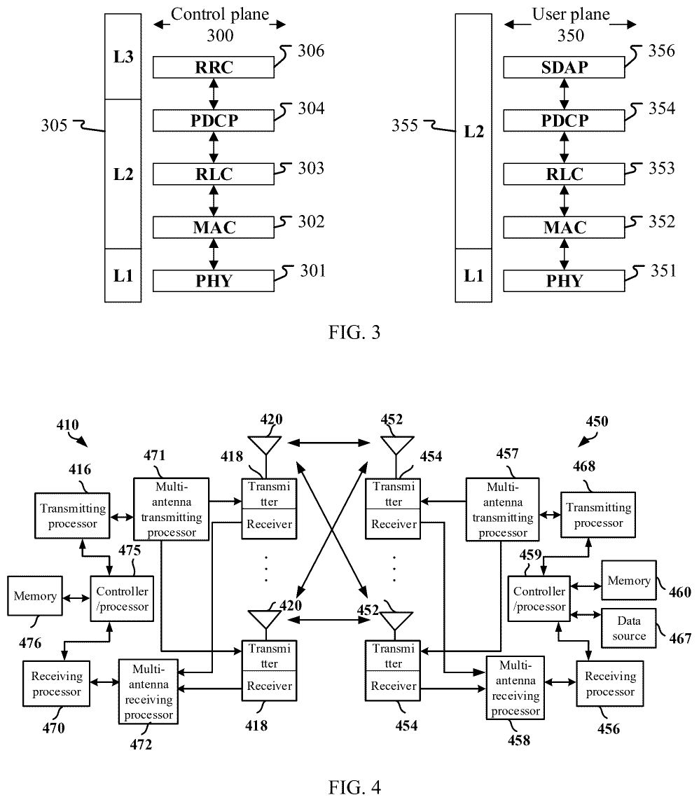

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything(V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., Layer 1 (L1), Layer 2 (L2) and Layer 3 (L3). The L1 is the lowest layer which performs various signal processing functions of PHY (i.e., PHYsical layer). The L1 is called PHY 301 in the present application. The L2 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service DataAdaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., Internet Protocol/IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated by the RRC 306.

In one embodiment, the first signaling is generated by the MAC302 or the MAC352.

In one embodiment, the first signaling is generated by the PHY 301 or the PHY 351.

In one embodiment, the first signal is generated by the RRC 306.

In one embodiment, the first signal is generated by the MAC302 or the MAC352.

In one embodiment, the first signal is generated by the PHY 301 or the PHY 351.

In one embodiment, the second signal is generated by the RRC 306.

In one embodiment, the second signal is generated by the MAC302 or the MAC352.

In one embodiment, the second signal is generated by the PHY 301 or the PHY 351.

In one embodiment, the higher layer in the present application refers to a layer above the PHY layer.

In one embodiment, the higher layer in the present application comprises a MAC layer.

In one embodiment, the higher layer in the present application comprises an RRC layer.

### Embodiment 4

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using ACKnowledgement (ACK) and/or Negative ACKnowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a first signaling, the first signaling being used to configure a first RS resource, a first signal and a second signal, the first signal being associated with a first device identification (ID); and receives a second signal, the second signal being associated with a second device ID; the first signaling is identified by the second device ID, the first RS resource is spatially correlated to the first signal, and whether receiving the second signal includes detecting the first signal depends on a spatial correlation between the second signal and the first RS resource.

In one embodiment, the second communication device 450 comprises a memory that stores a computer readable instruction program. The computer readable instruction program generates actions when executed by at least one processor. The actions include: receiving a first signaling; and receiving a second signal.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a first signaling, the first signaling being used to configure a first RS resource, a first signal and a second signal, the first signal being associated with a first device identification (ID); and transmits a second signal, the second signal being associated with a second device ID; the first signaling is identified by the second device ID, the first RS resource is spatially correlated to the first signal, and whether the second signal includes detecting the first signal when being received depends on a spatial correlation between the second signal and the first RS resource.

In one embodiment, the first communication device 410 comprises a memory that stores a computer readable instruction program. The computer readable instruction program generates actions when executed by at least one processor. The actions include: transmitting a first signaling; and transmitting a second signal.

In one embodiment, the first node in the present application comprises the second communication device 450.

In one embodiment, the second node in the present application comprises the first communication device 410.

In one embodiment, the second communication device 450 supports RIS.

In one embodiment, the first communication device 410 supports RIS.

In one embodiment, at least one of the antenna 420, the transmitter 418, the transmitting processor 416, the multi-antenna transmitting processor 471, the controller/processor 475 or the memory 476 is used for transmitting the first signaling; at least one of the antenna 452, the receiver 454, the receiving processor 456, the multi-antenna receiving processor 458, the controller/processor 459, the memory 460 or the data source 467 is used for receiving the first signaling.

In one embodiment, at least one of the antenna 420, the transmitter 418, the transmitting processor 416, the multi-antenna transmitting processor 471, the controller/processor 475 or the memory 476 is used for transmitting the second signal; at least one of the antenna 452, the receiver 454, the receiving processor 456, the multi-antenna receiving processor 458, the controller/processor 459, the memory 460 or the data source 467 is used for receiving the second signal.

In one embodiment, at least one of the antenna 420, the transmitter 418, the transmitting processor 416, the multi-antenna transmitting processor 471, the controller/processor 475 or the memory 476 is used for transmitting the first signal.

### Embodiment 5

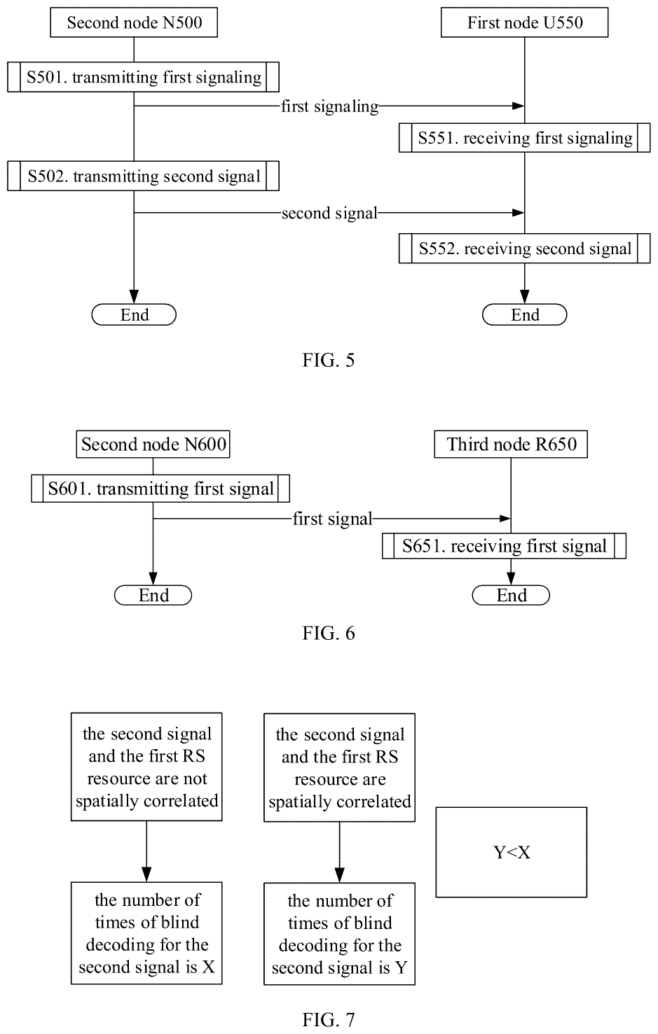

Embodiment 5 illustrates a flowchart of transmission between a first node and a second node according to one embodiment of the present application, as shown in FIG. 5. In FIG. 5, a second node N500 and a first node U550 are in communication via a radio link. It should be particularly noted that the sequence illustrated herein does not set any limit to the signal transmission order or implementation order in the present application.

The second node N500 transmits a first signaling in step S501, and transmits a second signal in step S502.

The first node U550 receives a first signaling in step S551; and receives a second signal in step S552.

In Embodiment 5, the first signaling is used to configure a first RS resource, a first signal and a second signal, the first signal being associated with a first device identification (ID); and the second signal is associated with a second device ID; the first signaling is identified by the second device ID, the first RS resource is spatially correlated to the first signal, and whether receiving the second signal includes detecting the first signal depends on a spatial correlation between the second signal and the first RS resource.

In one embodiment, the second signal is a control signaling sent by the second node to the first node.

In one embodiment, the second signal is data sent by the second node to the first node.

In one embodiment, the first signaling includes scheduling information for the second signal.

### Embodiment 6

Embodiment 6 illustrates a flowchart of transmission between a second node and a third node according to one embodiment of the present application, as shown in FIG. 6. In FIG. 6, a second node N600 and a third node R650 are in communication via a radio link.

The second node N600 transmits a first signal in step S601.

The third node R650 receives a first signal in step S651.

In one embodiment, the first signal is a control signal sent by the second node to the third node.

In one embodiment, the first signal and the second signal are transmitted simultaneously.

In one embodiment, there is an overlap between symbols occupied by the first signal and symbols occupied by the second signal.

In one embodiment, there exists one time-domain symbol being occupied by both the first signal and the second signal.

### Embodiment 7

Embodiment 7 illustrates a schematic diagram of blind decoding for a second signal according to one embodiment of the present application, as shown in FIG. 7. In FIG. 7, when the second signal and the first RS resource are not spatially correlated, a number of times of blind decoding for the second signal is X; when the second signal and the first RS resource are spatially correlated, the number of times of blind decoding for the second signal is Y; both X and Y are positive integers, and Y<X.

In Embodiment 7, the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

In one embodiment, the detecting the first signal comprises: decoding the received superimposed signal to obtain the first signal, and subtracting the generated first signal from the received superimposed signal to decode the second signal.

In one subembodiment, the superimposed signal is a superposition of the first signal and the second signal.

In one subembodiment, the superimposed signal comprises the first signal and the second signal.

In one embodiment, the first signal and the second signal are partially overlapping.

In one embodiment, part of time-domain and frequency-domain resources used by the first signal and the second signal are overlapping.

In one embodiment, part of time-domain or frequency-domain resources used by the first signal and the second signal are overlapping

In one embodiment, part of time-frequency resources used by the first signal and the second signal are overlapping.

In one embodiment, part of time-domain resources used by the first signal and the second signal are overlapping.

In one embodiment, part of frequency-domain resources used by the first signal and the second signal are overlapping.

In one embodiment, part of REs occupied by the first signal and the second signal are identical.

In one embodiment, the first signal and the second signal are fully overlapping.

In one embodiment, time-frequency resources used by the first signal and the second signal are fully overlapping.

In one embodiment, time-domain and frequency-domain resources used by the first signal and the second signal are fully overlapping.

In one embodiment, all of time-domain and frequency-domain resources used by the first signal are time-domain and frequency-domain resources used by the second signal.

In one embodiment, all of time-domain and frequency-domain resources used by the second signal are time-domain and frequency-domain resources used by the first signal.

In one embodiment, REs occupied by the first signal are equally occupied by the second signal.

In one embodiment, REs occupied by the second signal are equally occupied by the first signal.

In one embodiment, the blind decoding is implemented by means of algorithms of the terminal.

In one embodiment, the blind decoding procedure requires the terminal to know the encoding rate.

Typically, the detecting the first signal includes iterative decoding, and the receiving the second signal includes iterative decoding; that whether receiving the second signal includes detecting the first signal depends on a spatial correlation between the second signal and the first RS resource means: compared with cases in which the second signal and the first RS resource are not spatially correlated, fewer times of iterative decoding are performed for the second signal in cases in which the second signal and the first RS resource are spatially correlated.

### Embodiment 8

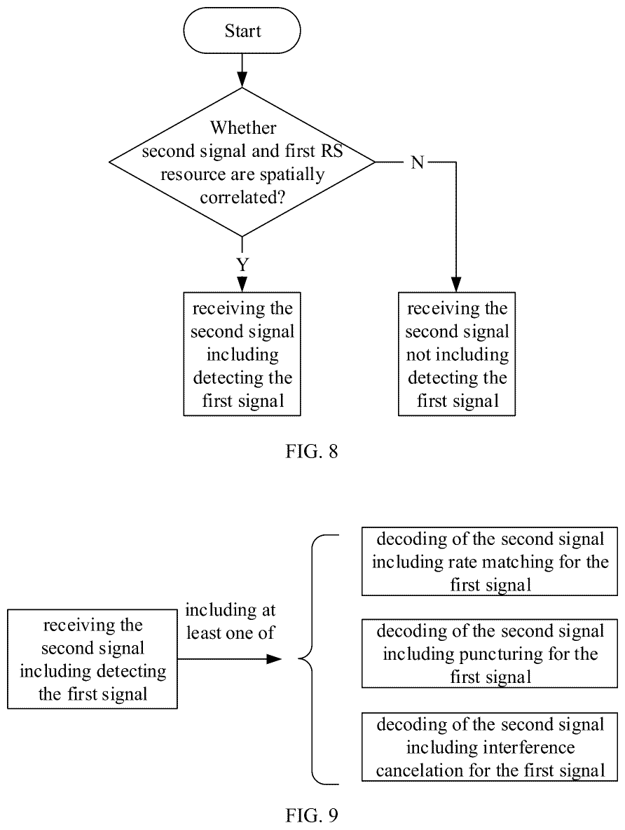

Embodiment 8 illustrates a schematic diagram of a relationship between receiving a second signal and detecting a first signal according to one embodiment of the present application, as shown in FIG. 8. In FIG. 8, whether the receiving the second signal includes the detecting the first signal is selected based on the spatial correlation between the second signal and the first RS resource.

In Embodiment 8, the second signal and the first RS resource are spatially correlated, the receiving the second signal including the detecting the first signal; or the second signal and the first RS resource are not spatially correlated, the receiving the second signal not including the detecting the first signal.

In one embodiment, when the second signal and the first RS resource are spatially correlated, the receiving the second signal includes the detecting the first signal.

In one embodiment, when the second signal and the first RS resource are spatially correlated, the receiving the second signal includes cancellation of interference with the first signal.

In one embodiment, when the second signal and the first RS resource are not spatially correlated, the receiving the second signal does not include the detecting the first signal.

In one embodiment, when the second signal and the first RS resource are not spatially correlated, the receiving the second signal does not analyze the first signal.

In one embodiment, when the second signal and the first RS resource are not spatially correlated, the receiving the second signal does not cancel the interference with the first signal.

### Embodiment 9

Embodiment 9 illustrates a schematic diagram of the meaning of receiving a second signal including detecting a first signal according to one embodiment of the present application, as shown in FIG. 9. In FIG. 9, the meaning of the receiving the second signal including the detecting the first signal includes at least one of what is contained in the right parenthesis.

In Embodiment 9, the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

In one embodiment, the meaning of the above phrase decoding of the second signal including rate matching for the first signal includes that overlapping RE(s) between REs occupied by the first signal and REs occupied by the second signal is/are not used for transmitting the second signal.

In one embodiment, the meaning of the above phrase decoding of the second signal including rate matching for the first signal includes that the second signal occupies only REs other than the REs occupied by the first signal.

In one embodiment, the meaning of the above phrase decoding of the second signal including rate matching for the first signal includes that by adjusting the code rate the second signal achieves occupancy of only REs other than those occupied by the first signal.

In one embodiment, the rate matching in this application includes bit selection.

In one subembodiment, the bit selection is the selection of discarding or repeating of some bits based on a relative magnitude of the length of the input bit stream for rate matching and the actual channel transmitted bits.

In one subembodiment, the method of bit selection comprises: Puncturing, Shortening and Repetition.

In one embodiment, the rate matching in this application includes bit-interleaving.

In one embodiment, the rate matching in this application includes bit collection.

In one subembodiment, the bit collection is for cascading bits of respective code blocks together.

In one embodiment, the rate matching in this application includes sub-block interleaving.

In one subembodiment, the sub-block interleaving is to divide the data into multiple sub-blocks and to transmit them in an interleaved manner to improve the reliability of the data.

In one subembodiment, the sub-block interleaving is intended to allow system bits to be spread out in modulation symbols to improve performance.

In one embodiment, the rate matching in this application is defined per coded block.

In one embodiment, the rate matching in this application is performed independently for each coded block.

In one embodiment, the rate matching in this application is for matching rates of data transmission between a sender and a receiver.

In one embodiment, the rate matching in this application is for making the bit stream length with the actual transmission capacity.

In one embodiment, the rate matching in this application is for aligning the number of encoded bits with the actual number of resources available for transmission

In one embodiment, the meaning of the above phrase decoding of the second signal including puncturing for the first signal includes that symbols in overlapping RE(s) between REs occupied by the first signal and REs occupied by the second signal are punctured.

In one embodiment, the meaning of the above phrase decoding of the second signal including puncturing for the first signal includes that symbols in overlapping RE(s) between REs occupied by the first signal and REs occupied by the second signal are not used for decoding of the second signal.

In one embodiment, the meaning of the above phrase decoding of the second signal including puncturing for the first signal includes that a portion of the original coding bits of the second signal are deleted, for the purpose of adjusting the code length.

In one embodiment, the meaning of the above phrase decoding of the second signal including puncturing for the first signal includes that a portion of the original coding bits of the second signal are not transmitted, for the purpose of adjusting the code length.

In one embodiment, the meaning of the above phrase decoding of the second signal including interference cancellation for the first signal includes that the decoding of the second signal includes iterative decoding for the first signal.

In one embodiment, the meaning of the above phrase decoding of the second signal including interference cancellation for the first signal includes that the decoding of the second signal includes removing interference generated by the first signal from the second signal.

In one embodiment, the meaning of the above phrase decoding of the second signal including interference cancellation for the first signal includes that the decoding of the second signal includes whitening the interference of the first signal with the second signal.

In one embodiment, the meaning of the above phrase decoding of the second signal including interference cancellation for the first signal includes that the decoding of the second signal includes canceling the interference of the second signal with the first signal.

In one embodiment, for the transmitting end of the second signal, the meaning of transmitting the second signal when the receiving the second signal includes the detecting the first signal includes at least one of:
transmitting of the second signal including rate matching for the first signal;
transmitting of the second signal including puncturing for the first signal.

In one embodiment, for the transmitting end of the second signal, encoding of the second signal includes at least one of:
encoding of the second signal including rate matching for the first signal; or
encoding of the second signal including puncturing for the first signal.

### Embodiment 10

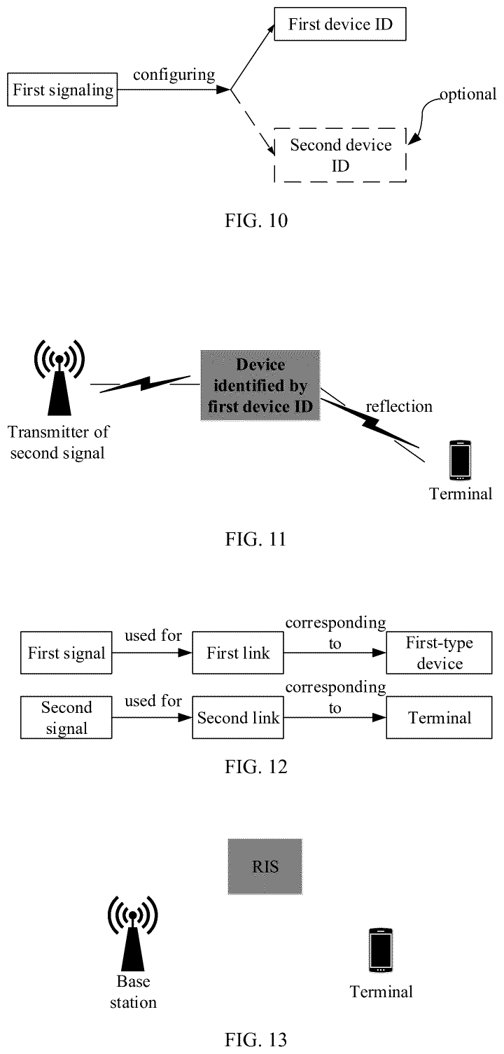

Embodiment 10 illustrates a schematic diagram of a first signaling configuration according to one embodiment of the present application, as shown in FIG. 10. In FIG. 10, the first signaling configures the first device ID and that the first signaling configures the second device ID is optional.

In Embodiment 10, the first signaling configures at least a former of the first device ID or the second device ID.

In one embodiment, one sub-signaling of the first signaling configures at least a former of the first device ID or the second device ID.

In one embodiment, one sub-signaling of the first signaling configures the first device ID.

In one embodiment, one sub-signaling of the first signaling configures the first device ID and the second device ID.

In one embodiment, the first device ID is for the first-type devices in the present application.

In one embodiment, the second device ID is for the terminals in the present application.

In one embodiment, the first device ID is configured for the third node in the present application.

In one embodiment, the second device ID is configured for the first node in the present application.

In one embodiment, the first signaling configures the first device ID.

In one embodiment, the first signaling configures the first device ID and the second device ID.

In one embodiment, the first signaling does not configure the second device ID.

In one embodiment, the first device ID is a Physical Cell Identity (PCI), while the second device ID is an RNTI.

In one embodiment, the first device ID is a RIS Cell Identity (RCI).

In one embodiment, the first device ID is a Physical RIS Identity (PRI).

In one embodiment, the first device ID is used for identifying a RIS, while the second device ID is used for identifying a UE.

### Embodiment 11

Embodiment 11 illustrates a schematic diagram of device functionality identified by a first device ID according to one embodiment of the present application, as shown in FIG. 11. In FIG. 11, a transmitter of a second signal transmits a radio signal, and a device identified by the first device ID performs reflection of the radio signal to a terminal.

In Embodiment 11, a device identified by the first device ID is used to reflect a radio signal sent from a transmitter of the second signal.

In one embodiment, the device identified by the first device ID comprises the third node of the present application.

In one embodiment, the device identified by the first device ID comprises RIS(s).

In one embodiment, the device identified by the first device ID comprises a RIS.

In one embodiment, the device identified by the first device ID comprises a RIS group.

In one embodiment, the device identified by the first device ID comprises multiple RISs.

In one embodiment, the device identified by the first device ID comprises a receiving module, the receiving module being used to receive the first signal.

In one embodiment, the device identified by the first device ID comprises a reflecting module, the reflecting module being used to reflect a radio signal sent from the second node.

In one embodiment, the device identified by the first device ID comprises a control module, the control module being used to control a reflecting module.

In one embodiment, the behavior of a device identified by the first device ID being used to reflect a radio signal sent from a transmitter of the second signal is controlled by a first signal.

In one embodiment, the behavior of a device identified by the first device ID being used to reflect a radio signal sent from a transmitter of the second signal is controlled by a second signal of the present application.

In one embodiment, the behavior of a device identified by the first device ID being used to reflect a radio signal sent from a transmitter of the second signal is controlled by a third signal of the present application.

In one embodiment, the behavior of a device identified by the first device ID being used to reflect a radio signal sent from a transmitter of the second signal is controlled by a control module for RIS.

In one embodiment, a device identified by the first device ID controls the reflection of a radio signal sent from a transmitter of the second signal via a first signal.

In one embodiment, a device identified by the first device ID controls a reflection beam of a radio signal sent from a transmitter of the second signal via a first signal.

In one embodiment, a device identified by the first device ID controls a reflection beam pattern of a radio signal sent from a transmitter of the second signal via a first signal.

In one embodiment, a device identified by the first device ID indicates a reflection beam index of a radio signal sent from a transmitter of the second signal via a first signal.

### Embodiment 12

Embodiment 12 illustrates a schematic diagram of relations between signals, links and devices according to one embodiment of the present application, as shown in FIG. 12. In FIG. 12, a first signal is used for a first link, the first link corresponding to first-type devices; a second signal is used for a second link, the second link corresponding to terminals.

In Embodiment 12, the first signal and the second signal are respectively used for a first link and a second link; the first link corresponds to first-type devices, while the second link corresponds to terminals; the first-type devices are different from the terminals.

In one embodiment, the first link is a link between the second node and the third node.

In one embodiment, the first link is a link between the base station and the first-type device.

In one embodiment, the first link is a wireless link.

In one embodiment, the first link is a Backhaul link.

In one embodiment, the first signal is used to configure a first link.

In one embodiment, the second signal is used to configure a second link.

In one embodiment, the first-type device is a passive relay node.

In one embodiment, the first-type device is a RIS.

In one embodiment, the first-type device is an Intelligent Reflecting Surface (IRS).

In one embodiment, the first-type device is multiple RISs.

In one embodiment, the first-type device is a RIS group.

In one embodiment, the first-type device comprises a RIS.

In one embodiment, the first-type device comprises multiple RIS panels.

In one embodiment, the first-type device comprises multiple RIS reflective panels.

In one embodiment, the first-type device comprises a control module for RIS.

In one embodiment, the first-type device comprises a control unit for RIS.

In one embodiment, the first-type device comprises a reflective unit for RIS.

In one embodiment, the first-type device comprises a reflection module for RIS.

In one embodiment, the second link is a link between the second node and the first node.

In one embodiment, the second link is a wireless link.

In one embodiment, the second link is an Access link.

In one embodiment, the second link is for a Uu port.

### Embodiment 13

Embodiment 13 illustrates a schematic diagram of Reconfigurable Intelligence Surface (RIS) according to one embodiment of the present application, as shown in FIG. 13. In FIG. 13, the RIS means: a Reconfigurable Intelligent Surface, the base station comprising the second node as described in the present application; the terminal comprising the first node as described in the present application, and the RIS comprising the third node as described in the present application.

In one embodiment, the first signal is a signal sent from the base station to the RIS.

In one embodiment, the first signal is a control signal sent from the base station to the RIS.

In one embodiment, the RIS selects a reflective beam to reflect a radio signal from the base station.

In one embodiment, the terminal receives the first signal reflected by the RIS.

In one embodiment, the second signal is sent to the terminal by the base station.

In one embodiment, the second signal is interfered with by the first signal reflected by the RIS.

In one embodiment, the second signal is not reflected by the RIS.

In one embodiment, the second signal is not reflected by the third node.

In one embodiment, the first link is a link between the base station and the RIS.

In one embodiment, the second link is a link between the base station and the terminal.

In one embodiment, the second link is a direct link between the base station and the terminal.

### Embodiment 14

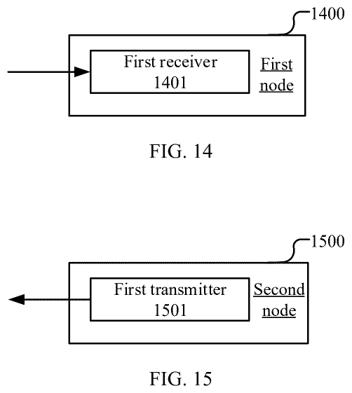

Embodiment 14 illustrates a structure block diagram of a processing device in a first node in an example, as shown in FIG. 14. In FIG. 14, a processing device 1400 in a first node comprises a first receiver 1401.

In Embodiment 14, the first receiver 1401 receives a first signaling, the first signaling being used to configure a first RS resource, a first signal and a second signal, the first signal being associated with a first device identification (ID); and the first receiver 1401 receives a second signal, the second signal being associated with a second device ID; the first signaling is identified by the second device ID, the first RS resource is spatially correlated to the first signal, and whether receiving the second signal includes detecting the first signal depends on a spatial correlation between the second signal and the first RS resource.

In one embodiment, the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

In one embodiment, the second signal and the first RS resource are spatially correlated, the receiving the second signal including the detecting the first signal; or the second signal and the first RS resource are not spatially correlated, the receiving the second signal not including the detecting the first signal.

In one embodiment, the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

In one embodiment, the first signaling configures at least a former of the first device ID or the second device ID.

In one embodiment, a device identified by the first device ID is used to reflect a radio signal sent from a transmitter of the second signal.

In one embodiment, the first signal and the second signal are respectively used for a first link and a second link; the first link corresponds to first-type devices, while the second link corresponds to terminals; the first-type devices are different from the terminals.

In one embodiment, the first node is a UE.

In one embodiment, the first node is a relay node.

In one embodiment, the first receiver 1401 comprises at least one of the antenna 452, the receiver 454, the receiving processor 456, the multi-antenna receiving processor 458, the controller/processor 459, the memory 460 or the data source 467 in Embodiment 4.

### Embodiment 15

Embodiment 15 illustrates a structure block diagram of a processing device used in a second node according to one embodiment of the present application, as shown in FIG. 15. In FIG. 15, a processing device 1500 in a second node comprises a first transmitter 1501.

In Embodiment 15, the first transmitter 1501 transmits a first signaling, the first signaling being used to configure a first RS resource, a first signal and a second signal, the first signal being associated with a first device identification (ID); and the first transmitter 1501 transmits a second signal, the second signal being associated with a second device ID; the first signaling is identified by the second device ID, the first RS resource is spatially correlated to the first signal, and whether receiving the second signal includes detecting the first signal depends on a spatial correlation between the second signal and the first RS resource.

In one embodiment, the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

In one embodiment, the second signal and the first RS resource are spatially correlated, the receiving the second signal including the detecting the first signal; or the second signal and the first RS resource are not spatially correlated, the receiving the second signal not including the detecting the first signal.

In one embodiment, the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

In one embodiment, the first signaling configures at least a former of the first device ID or the second device ID.

In one embodiment, a device identified by the first device ID is used to reflect a radio signal sent from a transmitter of the second signal.

In one embodiment, the first signal and the second signal are respectively used for a first link and a second link; the first link corresponds to first-type devices, while the second link corresponds to terminals; the first-type devices are different from the terminals.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IOT), Radio Frequency Identification (RFID) terminals, Narrow Band Internet of Things (NB-IOT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling, the first signaling being used to configure a first RS resource, a first signal and a second signal, the first signal being associated with a first device identification (ID); and
receiving the second signal, the second signal being associated with a second device ID;
wherein the first signaling is identified by the second device ID, the first RS resource is spatially correlated to the first signal, and whether receiving the second signal includes detecting the first signal depends on a spatial correlation between the second signal and the first RS resource.

2. The first node according to claim 1, characterized in that the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

3. The first node according to claim 1, characterized in that the second signal and the first RS resource are spatially correlated, the receiving the second signal including the detecting the first signal; or the second signal and the first RS resource are not spatially correlated, the receiving the second signal not including the detecting the first signal.

4. The first node according to claim 1, characterized in that the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

5. The first node according to claim 1, characterized in that the first signaling configures at least a former of the first device ID or the second device ID.

6. The first node according to claim 1, characterized in that a device identified by the first device ID is used to reflect a radio signal sent from a transmitter of the second signal.

7. The first node according to claim 4, characterized in that the first signal and the second signal are respectively used for a first link and a second link; the first link corresponds to first-type devices, while the second link corresponds to terminals; the first-type devices are different from the terminals.

8. The first node according to claim 1, characterized in that the first signaling is used to configure time-frequency resources occupied by the first signal, and the first signaling is used to indicate a transmission power value of the first signal.

9. The first node according to claim 1, characterized in that the first signal is used to control a node other than the first node, while the second signal is used to control the first node.

10. The first node according to claim 1, characterized in that there exists overlapping time-frequency resource between the first signal and the second signal.

11. The first node according to claim 1, characterized in that the detecting the first signal includes at least one of:
resuming the first signal having been received;
whitening an interference of the first signal with the second signal;
eliminating the interference of the first signal with the second signal;
performing channel decoding for at least a first channel occupied by the first signal;
receiving a reference signal on at least second RS resource occupied by the first signal, or performing channel estimation for a reference signal on the second RS resource.

12. The first node according to claim 1, characterized in that when the second signal and the first RS resource are spatially correlated, the receiving the second signal includes the detecting the first signal; when the second signal and the first RS resource are not spatially correlated, the receiving the second signal does not include the detecting the first signal.

13. The first node according to claim 1, characterized in that the detecting the first signal includes iterative decoding, and the receiving the second signal includes iterative decoding; that whether receiving the second signal includes detecting the first signal depends on a spatial correlation between the second signal and the first RS resource means: compared with cases in which the second signal and the first RS resource are not spatially correlated, fewer times of iterative decoding are performed for the second signal in cases in which the second signal and the first RS resource are spatially correlated.

14. The first node according to claim 6, characterized in that the device identified by the first device ID comprises a RIS.

15. The first node according to claim 6, characterized in that the device identified by the first device ID comprises a receiving module, the receiving module being used to receive the first signal; and the device identified by the first device ID comprises a reflecting module, the reflecting module being used to reflect the radio signal sent from the transmitter of the second signal.

16. A second node for wireless communications, comprising:
a first transmitter, transmitting a first signaling, the first signaling being used to configure a first RS resource, a first signal and a second signal, the first signal being associated with a first device identification (ID); and
transmitting the second signal, the second signal being associated with a second device ID;
wherein the first signaling is identified by the second device ID, the first RS resource is spatially correlated to the first signal, and whether the second signal includes detecting the first signal when being received depends on a spatial correlation between the second signal and the first RS resource.

17. The second node according to claim 16, characterized in that the detecting the first signal includes blind decoding, and the receiving the second signal includes blind decoding; that whether receiving the second signal includes detecting the first signal depends on a spatial correlation between the second signal and the first RS resource means: compared with cases in which the second signal and the first RS resource are not spatially correlated, fewer times of blind decoding are performed for the second signal in cases in which the second signal and the first RS resource are spatially correlated.

18. The second node according to claim 16, characterized in that the second signal and the first RS resource are spatially correlated, the receiving the second signal including the detecting the first signal; or the second signal and the first RS resource are not spatially correlated, the receiving the second signal not including the detecting the first signal.

19. The second node according to claim 16, characterized in that the meaning of the receiving the second signal including the detecting the first signal includes at least one of:
decoding of the second signal including rate matching for the first signal; or
decoding of the second signal including puncturing for the first signal; or
decoding of the second signal including interference cancelation for the first signal.

20. A method in a first node for wireless communications, comprising:
receiving a first signaling, the first signaling being used to configure a first RS resource, a first signal and a second signal, the first signal being associated with a first device identification (ID); and receiving the second signal, the second signal being associated with a second device ID;
wherein the first signaling is identified by the second device ID, the first RS resource is spatially correlated to the first signal, and whether receiving the second signal includes detecting the first signal depends on a spatial correlation between the second signal and the first RS resource.
